(19) United States
(12) Patent Application Publication
(10) Pub. No.: US 2007/0013226 A1
(43) Pub. Date: Jan. 18, 2007

(54) Rim Cover

(76) Inventor: Timothy G. Updegraph, Erin, NY (US)

Correspondence Address: PATWRITE LLC, 408 W. MAIN ST., MARSHALLTOWN, IA, 50158-5759, US

(21) Appl. No.: 11/458,073

(22) Filed: Jul. 17, 2006

Related U.S. Application Data
(60) Provisional application No. 60/700,451, filed on Jul. 15, 2005.

(51) Int. Cl. B60B 7/00

(52) U.S. Cl. 301/37.104

(57) ABSTRACT

The present invention is for a rim cover that protects an automobile wheel from cleaning products designed to clean tires. Additionally, the present invention helps protects brake systems while cleaning tires. In an embodiment, snaps are provided around a circular shaped cover that lows the cover to snap in place to protect the wheel. Another embodiment provides a pair of securing arms that are ratcheted in place and push against the inner circumference of a wheel and thereby securing the cover. A ratchet release mechanism allows for removal. In yet another embodiment, a cover is provided that has a rotatable hook that may be inserted in any opening in a wheel and then pulled tight against the wheel. In still another embodiment of the present invention includes snap hook grippers that are displaced then released against a wheel to secure the cover. In another embodiment of the present invention includes a center push mechanism that allows easy attachment and removal of the cover by simply pushing down or pulling up in the center of the cover. Secure arms are forced outward against the wheel when engaged.

### RELATED APPLICATIONS

This application claims priority and herein incorporates by reference U.S. provisional patent application No. 60/700,451, filed Jul. 15, 2005.

### BACKGROUND OF THE INVENTION

While the automotive industry has been shaped by numerous trends since its inception in the early 1900's, the last two decades have been marked by distinct changes in the composition and appearance of the wheel. Up until 1980, car wheels were predominantly made of steel, having an unattractive, dull finish. With an expanding economy and an increasing consumer emphasis on appearance and design, the automotive industry began to offer cars fitted with decorative chrome or aluminum wheels as an alternative to steel. The following decades experienced a steadily increasing demand for the more decorative wheels, and automakers began producing more new models outfitted with aluminum or chrome wheels. In addition, a growing number of consumers began replacing factory outfitted wheels with decorative and often elaborate chrome or aluminum wheels made by aftermarket producers. Furthermore, the preference for aluminum wheels was not limited to aesthetics; auto enthusiasts and high-end automakers began to prefer aluminum wheels because unlike the stamped and welded steel wheels, aluminum wheels can be cast and machined to precise tolerances.

Although aluminum and chrome wheels exhibit superior structural and aesthetic qualities, they have several disadvantages. Aluminum wheels are much more expensive than those made of steel. In contrast to the average price of a set of steel wheels which ranges between $200 to $500, a set of aluminum wheels ranges between a minimum price of $700 to prices in upwards of $8,000 for a set of premium aftermarket wheels, with the average being approximately $1,200/set. In addition, aluminum wheels are susceptible to corrosion, staining, or becoming scratched. Because aluminum wheels are often exposed to damage caused by acid rain, brake dust, road salts, and tar, they must be cleaned on a regular basis. Unfortunately, car-care products are also a source of damaging agents. In particular, chemicals used to clean and maintain tires are one of the most common sources of wheel damage. Tire cleaners are often composed of acidic substances which corrode aluminum wheels. In addition, many tire cleaning and maintenance products contain additives such as abrasives, silicone, and bleach which have the ability to corrode, stain, or scratch the surface of chrome or clear-coated aluminum wheels. The close proximity of the tire to the wheel greatly increases the chances of exposure to the harmful substances as they are applied to the tire, particularly because many of the products are applied by means of a particle spray or mist. Furthermore, tire maintenance and cleaning products have the ability to damage not only the wheels, but also other portions of the wheel assembly due to the design of the aluminum wheel. Often decorative chrome or aluminum wheels are designed with a series of relatively thin segments connecting the wheel hub to the outer rim, leaving open spaces which expose the interior of the wheel assembly. As a result, the use of acidic products or those with additives such as silicones or oils can ruin or compromise the operation of partially exposed brake pads and rotors upon contact.

Owners of automobiles with aluminum wheels have expressed great concern in maintaining and protecting the decorative wheels in which they have invested great pride and expense. Cognizant of the potential for damage, most tire maintenance product manufacturers have placed labels on their products which instruct owners to avoid contact with alloy or aluminum wheels during use. In response, some owners simply try to do their best to carefully apply the product without contacting the wheel. As evidenced by a myriad of web logs and message boards, many owners attempt to ascertain from others which products, if any, are safe to use with a particular type of wheel, often resulting in indefinite answers or mixed results. Consumer demand for decorative alloy or aluminum wheels continues to grow, and as a result, an increasing number of individuals will own automobiles with wheels susceptible to damage. Because automobile maintenance and care is an integral part of automobile safety and enjoyment, consumers are in need of a device that allows them to clean their car without ruining their decorative wheels.

### SUMMARY OF THE INVENTION

The present invention is for a rim cover that protects an automobile wheel from cleaning products designed to clean tires. Additionally, the present invention helps protects brake systems while cleaning tires. In an embodiment, snaps are provided around a circular shaped cover that allows the cover to snap in place to protect the wheel. Another embodiment provides a pair of securing arms that are ratcheted in place and push against the inner circumference of a wheel and thereby securing the cover. A ratchet release mechanism allows for removal. In yet another embodiment, a cover is provided that has a rotatable hook that may be inserted in any opening in a wheel and then pulled tight against the wheel. In still another embodiment of the present invention includes snap hook grippers that are displaced then released against a wheel to secure the cover. In another embodiment of the present invention includes a center push mechanism that allows easy attachment and removal of the cover by simply pushing down or pulling up in the center of the cover. Secure arms are forced outward against the wheel when engaged.

Other features and advantages of the instant invention will become apparent from the following description of the invention which refers to the accompanying drawings.

### BRIEF DESCRIPTION OF THE DRAWINGS

FIG. 1 is a perspective view of an embodiment of the present invention.

FIG. 2 is a side view in partial cross section of an embodiment of the present invention.

FIG. 3 is a detailed view in partial cross section of the embodiment disclosed in FIG. 2.

FIG. 4 is a side view in partial cross section of another embodiment of the invention.

FIG. 5 is a bottom view in partial cross section of the embodiment illustrated in FIG. 4.

FIG. 6 is a side view in partial cross section of yet another embodiment of the invention.

FIG. 7 is a side view in partial cross section of still another embodiment of the invention.

FIG. 8 is a side view in partial cross section of an additional embodiment of the invention.

### DETAILED DESCRIPTION OF THE INVENTION

Reference is now made to the drawings in which reference numerals refer to like elements.

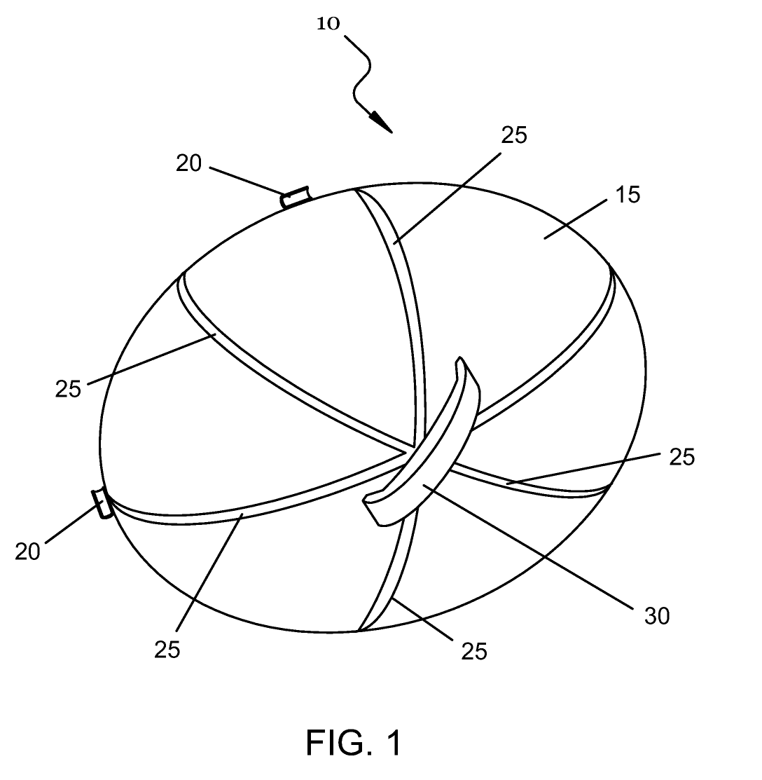

FIG. 1 is an embodiment of rim cover 10 comprising shell 15 and a plurality of snap clips 20 distributed around the outer perimeter of shell 15. A handle 30 is provided to aid in placing rim cover 10 over a wheel (not shown). Shell 15 is made of a low reactive material such as plastic. Of course other materials would be suitable such as fiberglass or other composite material. Rim cover 10 could also be made from metal. If metal is used, it would be useful to coat the metal with paint or an enamel finish as is known in the art. Shell 15 has a generally circular outer circumference of a size that matches standard wheel sizes. A user would need to use rim cover 10 that matches the size wheel which is to be protected.

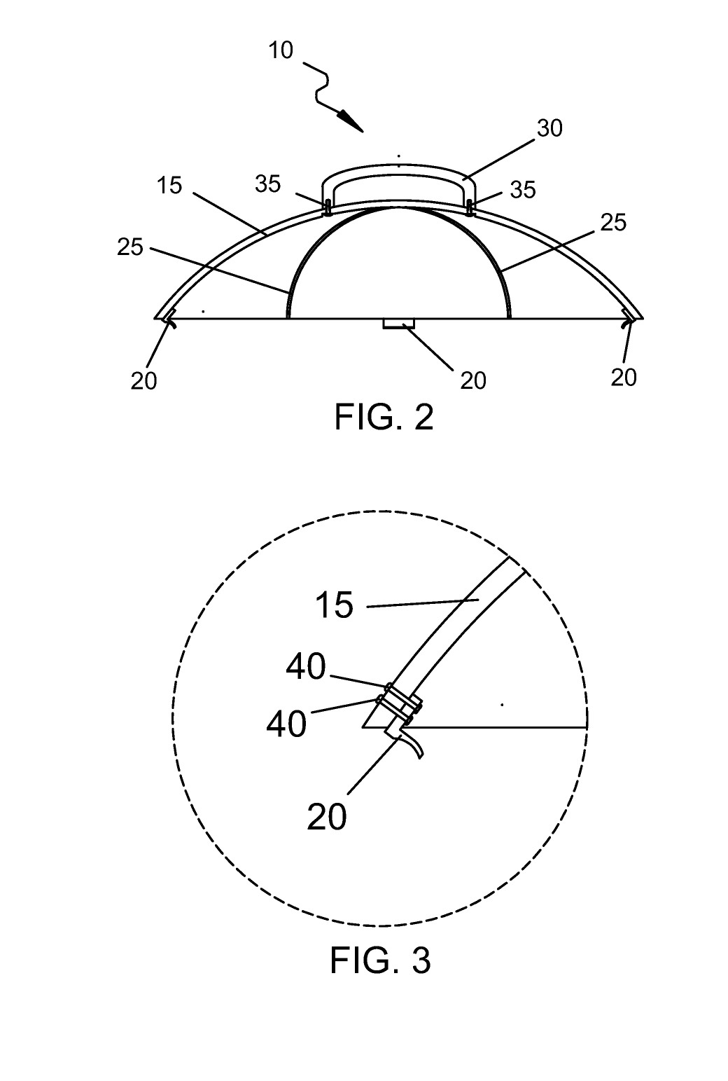

Now referring to FIGS. 2 and 3, rim cover 10 is shown in more detail with shell 15 having a plurality of stiffening ribs 25 to add structural integrity. Of course if the material used to produce rim cover 10 is strong enough, stiffening ribs 25 could be eliminated. Handle 30 is shown being secured with two machine screws 35 that pass through shell 15. Of course other means could be used to secure handle 30 to shell 15 such as producing handle from a one piece molding techniques so that shell 15 and handle 30 are formed together during the molding process as is known in the art. FIG. 3 shows a detail view of a clip 20 that is used to secure rim cover 10 to a wheel. Clip 20 is secured to shell 15 with rivets 40. Clip 20 is made of a resilient material such as Polyvinyl Chloride PVC with the addition of a plasticizer for flexibility and allows elastic deformation of clip 20 to provide the necessary force required to hold rim cover 10 in place during use. Again, as discussed above, other methods of attaching clips 20 may be used. Clip 20 is shown having a radius of curvature for applying pressure to the rim of a wheel (not shown) for easy insertion and removal. Other geometries are possible as is known in the art. Many hubcaps use similar clips to secure the hubcap to wheel.

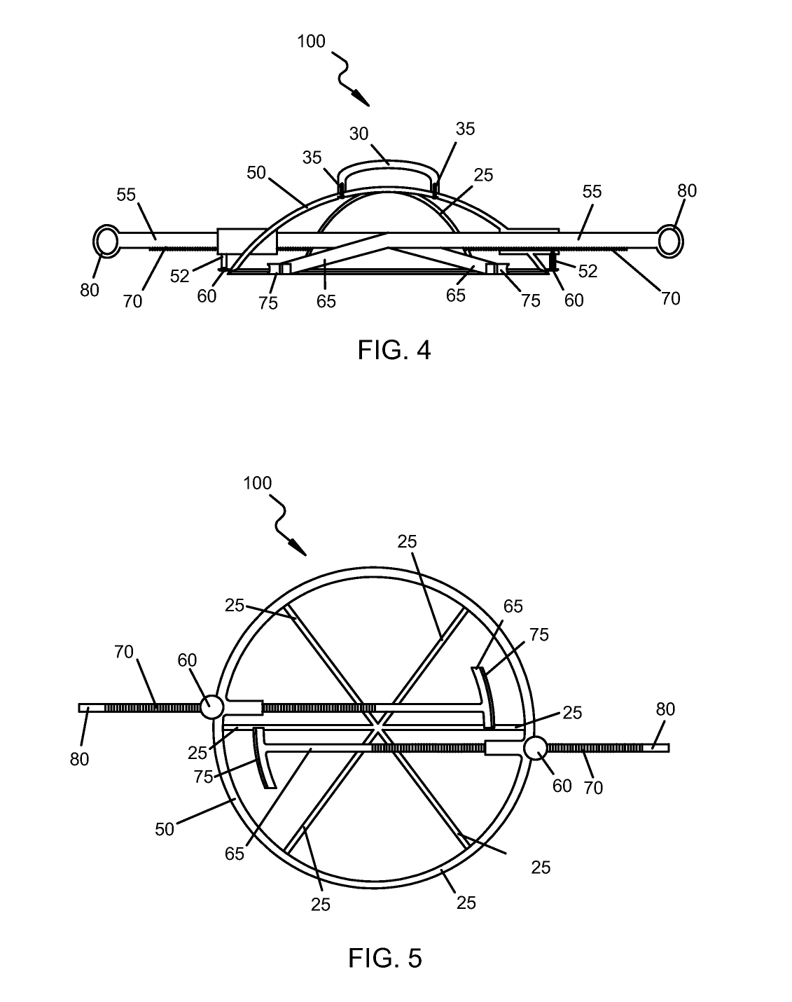

Now referring to FIGS. 4 and 5, a rim cover 100 is shown having shell 50 with reinforcing ribs 25. A handle 30 is used to aid in placement of rim cover 100 as discussed above. In this embodiment, rim cover 100 includes two secure bars 55 which are used to hold rim cover 100 in place during use. Secure bar 55 has a ratchet section 70 that interacts with ratchet assembly 52 providing an easy to use positioning system. In use, rim cover 100 is prepared by pulling ratchet release button 60 and pulling on secure bar pull 80 which moves secure bar towards the center of rim cover 100 and then this action is repeated with second secure bar 55. Rim cover 100 is then placed against wheel (not shown) and then secure bar 55 is pushed against an outer circumference of a wheel (not shown). Secure bar 55 has a clamping portion 75 located at an extremity of secure bar angled portion 65. Again this procedure is repeated with second secure bar 55. Clamping portion 75 is comprised of a compressible, non-abrasive material such as rubber and comes into contact with the rim (not shown).

Ratchet assembly 52 has a one way angled catch pin (not shown) positioned over a spring (not shown). The pin (not shown) couples with ratchet section 70 which allows secure bar 55 to slide towards the interior of shell 50. Pulling on ratchet release button 60 pulls catch pin (not shown) away from ratchet section 70 allowing the user disengage secure bars 55 from the rim (not shown) by sliding secure bars 55 outward.

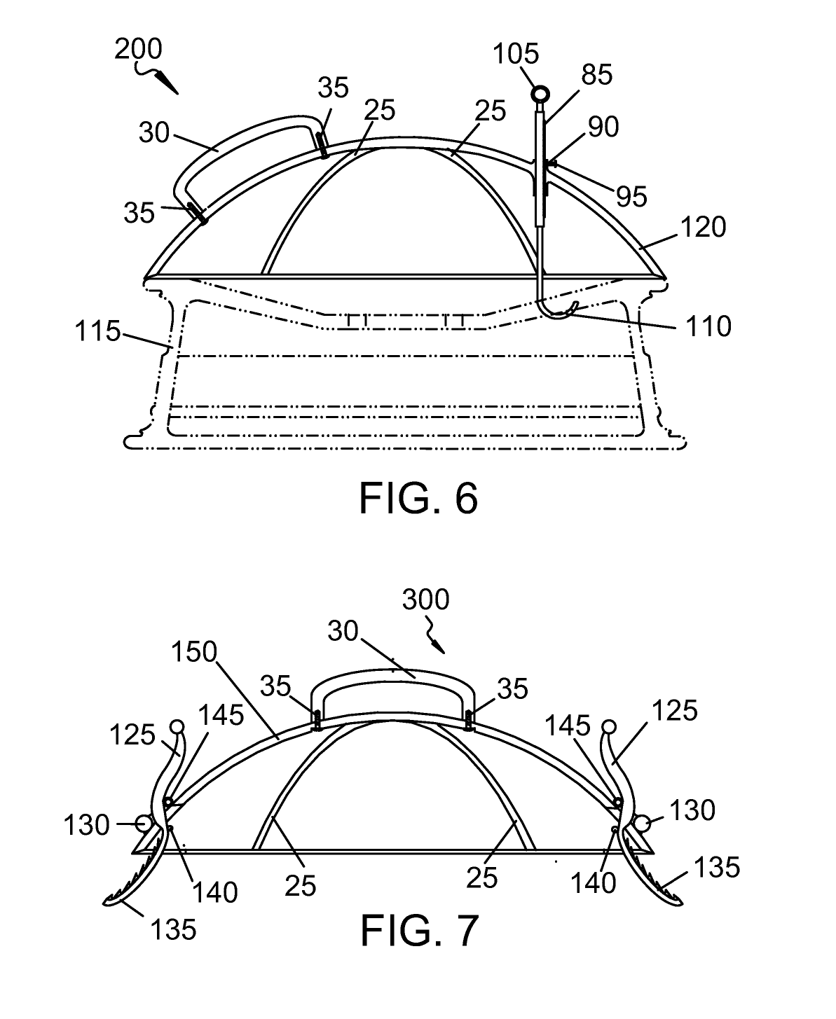

With reference to FIG. 6, a rim cover 200 has a shell 120 with a clamping hook ratchet arm 110 disposed therein. Clamping hook ratchet arm 110 includes a tubular ratchet section 85 and an arm handle 105. Clamping hook ratchet arm 110 may be rotated to accommodate different geometry openings in wheel 115. A rotating keep (not shown prevents clamping hook ratchet arm 110 from moving vertically within ratchet section 85. A ratchet assembly 90 has a ratchet release button 95 attached to a catch pin (not shown) to release clamping hook ratchet arm as discussed above. Clamping hook ratchet arm 110 is rotated and inserted into an opening in wheel 115 and then pulled upward to secure rim cover 200 to wheel 115. Clamping hook ratchet arm 110 is coated with a rubberized material to prevent damage to wheel 115. Although the embodiment shows only one clamping hook ratchet arm, other embodiments could include two or more clamping hook ratchet arms. Other embodiments utilizing a screw rather than a ratcheting system could be used to secure rim cover 200 to an opening in wheel 115.

A rim cover 300 is shown in FIG. 7 having a shell 150 with a plurality of spring loaded clips 125. Clips 125 has a gripping portion 135 that engages a portion of a wheel (not shown) to hold rim cover 300 in place during use. A spring 140, 145 wraps around clip 125 to bias clip 125 against pivot stop 130.

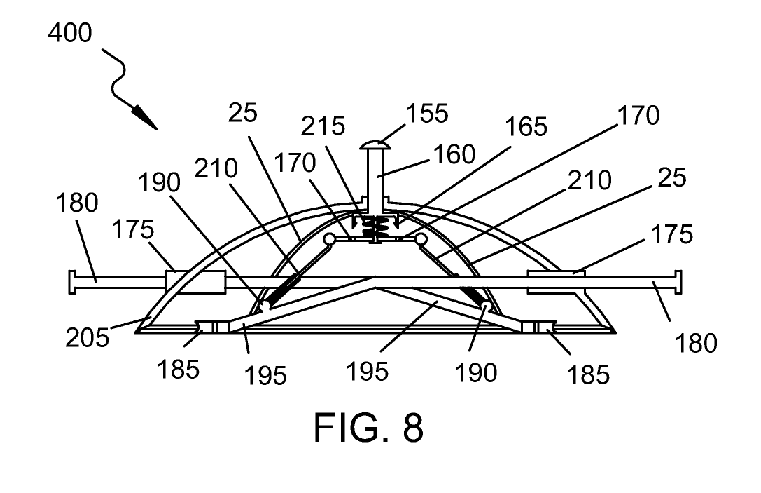

Now referring to FIG. 8, a rim cover 400 has a shell 205 with a center push rod 160 that deforms and moves secure rods 180 into position against a wheel (not shown). Center push rod 160 is biased by spring 215. A clip 165 removeably inserts into holes 170 once the maximum throw is reached to prevent accidental movement. A pull button 155 is used to pull center push rod 160 back and releasing secure rods 180. the downward force of center push rod 160 is converted into lateral movement through the use of lever rods 210 and hinge 190 which is connected to lower secure rod 195. As push rod 160 is depressed, lever rods 210 force gripping portions 185 against a rim (not shown) to hold rim cover 400 in place. Lateral movement busing 175 is provided to stabilize secure rod 180 and to force secure rods 180 to only move laterally.

Although the instant invention has been described in relation to particular embodiments thereof, many other variations and modifications and other uses will become apparent to those skilled in the art.

What is claimed is:

1. A rim cover to cover the opening of a wheel comprising:
a substantially circular shell having a diameter corresponding to a selected wheel size; and
at least two snap clips disposed along an outer circumference of said circular shell wherein said at least two snap clips are arranged to provide a sufficient holding force to prevent said rim cover from unintentional movement.

2. The rim cover to cover the opening of a wheel according to claim 1 wherein said at least two snap clips are made of plastic.

3. The rim cover to cover the opening of a wheel according to claim 1 further comprising a handle disposed on an outer surface of said circular shell.

4. The rim cover to cover the opening of a wheel according to claim 1 wherein said shell has a plurality of stiffening ribs disposed therein.

5. A rim cover to cover the opening of a wheel comprising:
a circular shell having a diameter corresponding to a selected wheel size;
a gripping means for holding said rim cover against said opening; and
a holding means for holding and positioning said rim cover.

6. The rim cover to cover the opening of a wheel according to claim 5 wherein said gripping means comprises:
at least two securing arms disposed at an offset on a bottom of said shell;
a ratchet portion disposed along a section of said at least two securing arms;
a ratchet engagement assembly biased against said ratchet portion to provide one way movement of said at least two securing arms; and
a release lever operatively connected to said ratchet engagement assembly to release said at least two secure arms from said ratchet engagement assembly.

7. The rim cover to cover the opening of a wheel according to claim 6 wherein said at least two secure arms having a gripping portion disposed on an end thereof for gripping the surface of said wheel.

8. The rim cover to cover the opening of a wheel according to claim 5 wherein said holding means is a handle disposed along an outer surface of said circular shell.

9. The rim cover to cover the opening of a wheel according to claim 6 wherein said at least two secure arms having a handle portion disposed on another end thereon.

10. The rim cover to cover the opening of a wheel according to claim 5 wherein said gripping means comprises:
at least one ratchet arm hook disposed generally perpendicular to the plane defined by said circular shell;
a ratchet portion disposed on a vertical portion of said at least one ratchet arm hook;
a ratchet engagement assembly biased against said ratchet portion to provide one way movement of said at least one ratchet arm hook; and
a release lever operatively connected to said ratchet engagement assembly to release said at least two secure arms from said ratchet engagement assembly.

11. The rim cover to cover the opening of a wheel according to claim 10 further comprising a ratchet arm hook sleeve disposed around said at least one ratchet arm hook wherein ratchet arm hook is rotatable therein.

12. The rim cover to cover the opening of a wheel according to claim 11 where said ratchet arm hook having a handle portion disposed on an end therein.

13. The rim cover to cover the opening of a wheel according to claim 5 wherein said circular shell having a plurality of stiffening ribs radially disposed therein.

14. The rim cover to cover the opening of a wheel according to claim 5 wherein said gripping means comprises:
at least two gripping clamps disposed along an outer portion of said circular shell; and
said at least two gripping clamps having a gripping portion for engaging an inner surface of said wheel.

15. The rim cover to cover the opening of a wheel according to claim 14 wherein said at least two gripping clamps being biased against said wheel by a spring.

16. The rim cover to cover the opening of a wheel according to claim 15 wherein said at least two gripping clamp having a lever portion.

17. The rim cover to cover the opening of a wheel according to claim 5 wherein said gripping means comprises:
at least two securing arms disposed at an offset on a bottom of said shell;
a lower lever hinge disposed along a lower section of said at least two secure arms;
an upper lever hinge;
a lever rotatably attached to said lower lever hinge and said upper lever hinge;
a push rod moveably connected to said upper lever hinge;
a spring for biasing said push rod against said circular shell; and
a secure arm sleeve disposed along a portion of said circular shell for supporting said at least two secure arm.

18. The rim cover to cover the opening of a wheel according to claim 17 wherein said at least two secure arm having a gripping portion disposed along an end therein for gripping an inner portion of said wheel.

19. The rim cover to cover the opening of a wheel according to claim 5 wherein said circular shell is made of plastic.

20. The rim cover to cover the opening of a wheel according to claim 1 wherein said substantially circular shell is made from plastic.
